(19) United States
(12) Patent Application Publication
(10) Pub. No.: US 2025/0263107 A1
(43) Pub. Date: Aug. 21, 2025

(54) STEERING SYSTEM

(71) Applicants: TOYOTA JIDOSHA KABUSHIKI KAISHA, Aichi-ken (JP); JTEKT CORPORATION, Aichi-ken (JP)

(72) Inventors: Atsushi SATOU, Toyota-shi (JP); Kazuki ITAZURI, Toyota-shi (JP); Fumihiko SATO, Okazaki-shi (JP); Tokuaki HIBINO, Toyota-shi (JP); Hiroki NITTA, Okazaki-shi (JP); Yuuta KAJISAWA, Okazaki-shi (JP)

(21) Appl. No.: 19/045,553

(22) Filed: Feb. 5, 2025

(30) Foreign Application Priority Data
Feb. 15, 2024 (JP) 2024-020886

(51) Int. Cl. B62D 5/00; B62D 5/04

(52) U.S. Cl. CPC B62D 5/005; B62D 5/0409; B62D 5/0421

(57) ABSTRACT

In a two-system steering system, a power supply system includes: first and second buses that are communicated with each other via a circuit breaker; first and second power supplies that are connected to the first and second buses, respectively; and a backup power supply including a battery to allow electric power to be supplied to both of first and second systems, and is configured such that, when one of the first and second buses has a ground fault, the circuit breaker cuts off the communication between the first and second buses, and the backup power supply supplies the electric power to both of the first and second systems. The backup power supply can suppress a situation where, during a time lag from detection of the ground fault to actuation of the circuit breaker, both of the first and second systems cannot be normally actuated.

### CROSS-REFERENCE TO RELATED APPLICATION

This application claims priority to Japanese Patent Application No. 2024-020886 filed on Feb. 15, 2024, incorporated herein by reference in its entirety.

### BACKGROUND

### 1. Technical Field

The disclosure relates to a steering system to be mounted on a vehicle.

### 2. Description of Related Art

Regarding a power supply system for various devices such as a steering device to be mounted on a vehicle, for example, there is a technology described in Japanese Unexamined Patent Application Publication No. 2023-32346 (JP 2023-32346 A). In this technology, a main power supply system including a normal load group including some devices and an auxiliary power supply, and a backup power supply system including a backup load group including some devices are provided. At the time of failure of the main power supply system, after a converter that is a main power supply is stopped, a connection line connecting both the systems to each other at normal times is cut off, and the backup power supply system is used to actuate the devices of the backup load group by supplying electric power from a converter that is a backup power supply.

### SUMMARY

In the technology described in JP 2023-32346 A, at the time of failure of the main power supply, the connection line is cut off, but there may occur a time lag from the detection of the failure of the main power supply system until the cut-off of the connection line. When the time lag occurs, there may be provided a state in which no electric power is supplied to both of the normal load group and the backup load group. When this state occurs, there is also expected a situation where, after the connection line is cut off, the backup load unit cannot be normally actuated. With such a situation being avoided, the practicality of a system including devices to be mounted on the vehicle, for example, a steering system can be improved. The disclosure has been made in view of such circumstances, and has an object to provide a highly practical steering system.

In order to achieve the above-mentioned object, a steering system of the disclosure is a steering system to be mounted on a vehicle, the steering system including:
a steering device including two systems of a first system and a second system, the two systems each including a power source;
a control drive device including two systems of a first system and a second system to control and drive the first system and the second system of the steering device, respectively, the two systems of the control drive device each including a driver that drives the power source and a controller that controls the driver;
two electric power supply buses connected in series to each other, the two electric power supply buses including a first bus to which the first system of the control drive device is connected to supply electric power to the first system of the control drive device, and a second bus to which the second system of the control drive device is connected to supply electric power to the second system of the control drive device;
a circuit breaker that disconnects the first bus and the second bus;
a first power supply connected to the first bus and a second power supply connected to the second bus; and
a backup power supply device that includes a battery and is configured to supply electric power from the battery, in which
the steering system is configured such that, at normal times, in a state in which the first bus and the second bus are communicated with each other, electric power is supplied from at least one of the first power supply and the second power supply, and, when one of the first bus and the second bus has a ground fault, the circuit breaker disconnects the first bus and the second bus such that the electric power is supplied via another one of the first bus and the second bus from a corresponding one of the first power supply and the second power supply connected to the other one of the first bus and the second bus to a corresponding one of the first system and the second system of the control drive device connected to the other one of the first bus and the second bus, and
the backup power supply device is configured to cause the electric power supplied from at least one of the first bus and the second bus to pass through itself, and, when supply of the electric power is cut off, automatically supply the electric power from the battery included in itself to at least the controllers of both of the first system and the second system of the control drive device.

The term “ground fault” means that a bus has a short circuit with a component having a ground potential. At normal times, when the ground fault occurs in one of the first bus and the second bus, since the first bus and the second bus are communicated with each other, the ground fault occurs in the other one of the first bus and the second bus as well. As a result, there is provided a state in which no electric power is supplied to any of the first system and the second system of the control drive device from any of the first power supply and the second power supply. In order to avoid such a situation, when the ground fault occurs in one of the first bus and the second bus, the circuit breaker cuts off the communication between the first bus and the second bus, and the electric power of a corresponding one of the first power supply and the second power supply is supplied via the other one of the first bus and the second bus to a corresponding one of the first system and the second system of the control drive device.

However, when the ground fault occurs in one of the first bus and the second bus, a time lag occurs from the detection of the ground fault until cut-off of the communication between the first bus and the second bus by the circuit breaker. Although the time lag is a short time, there is provided a state in which no electric power is supplied to both of the first system and the second system of the control drive device. In particular, when the controller is brought to a state of not being supplied with the electric power, the control by the controller is reset, and, even after the electric power is supplied again, both of the first system and the second system of the steering device fall into a state of not being able to be normally actuated.

The term “backup power supply device” refers to a device provided for avoiding this state, and the backup power supply device makes it possible to suppress a situation where no electric power is supplied to the controllers of both of the first system and the second system of the control drive device at a time point at which the ground fault has occurred. With the above-mentioned configuration, the steering system of the disclosure becomes highly practical.

The term “steering device” in the steering system of the disclosure (hereinafter sometimes referred to as “this steering system”) includes at least an actuator that turn a wheel or assists the turning of the wheel. The actuator is only required to include, for example, an electric motor or the like as the drive source. When the power source is the electric motor, for example, with the electric motor being a two-system motor, the steering device can be configured as a two-system device. Incidentally, when the electric motor is a DC brushless motor, for example, with a stator including two sets of coils, the electric motor is configured as a two-system motor.

The term “control drive device” refers to a device that controls and drives the steering device, and, in detail, refers to a device that controls the power source of the steering device. The two-system control drive device includes two drivers and two controllers so as to correspond to the two systems of the steering device. The “driver” can also be called a drive circuit, and, for example, an inverter may be adopted as the driver when the power source is a DC brushless motor. Further, the “controller” is only required to include, for example, a computer as a main component.

The term “first bus” and the term “second bus” both refer to electric power supply lines, that is, what are called electric wires, and may have a form of busbars. The first bus and the second bus respectively supply electric power to the first system and the second system of the control drive device, but other systems such as a brake system may be connected to the first bus and the second bus so that the first bus and the second bus supply electric power to the other systems as well. The “circuit breaker” may be what is called a switch that switches between mutual communication and non-communication between the two buses.

Power supplies that function as the “first power supply” and the “second power supply” may each be, for example, in a case of electric vehicles such as a battery electric vehicle and a hybrid electric vehicle, a converter that converts, into low-voltage electric power, high-voltage electric power from a drive battery that supplies electric power to a drive motor provided for driving the vehicle to travel. Further, the power supplies may each be an auxiliary battery such as a lead battery that has been conventionally used. The “backup power supply device” includes the above-mentioned “battery” therein, and the battery may be what is called a capacitor that is an electricity storage device having a small electricity storage capacity. It is to be noted that two or more first power supplies and two or more second power supplies may be disposed.

The configuration of the “backup power supply device”, in more detail, the configuration for automatically supplying electric power from the battery included in itself when the supply of the electric power from both of the first bus and the second bus is cut off is described in detail later.

It is to be noted that the backup power supply device may be configured to supply, with respect to both of the first system and the second system of the control drive device, the electric power from the battery to only the controller out of the driver and the controller. With such a configuration, it is possible to adopt a battery having a relatively small capacity. Further, the backup power supply device may be configured to supply, with respect to at least one of the first system and the second system of the control drive device, the electric power from the battery to both of the driver and the controller. When it is possible to supply the electric power to both of the driver and the controller, although a battery having a relatively large capacity is required, even during the above-mentioned time lag, the appropriate actuation of at least one of the first system and the second system of the steering device is ensured, and it is possible to further increase the reliability of the actuation of the steering system when the above-mentioned ground fault has occurred.

Further, the number of backup power supply devices to be disposed is not limited to one. For example, the backup power supply device may include a first backup power supply device configured to supply the electric power to the first system of the control drive device, and a second backup power supply device configured to supply the electric power to the second system of the control drive device.

This steering system may be what is called a steer-by-wire steering system. When the steer-by-wire steering system is employed, the steering system is only required to be configured such that each of the first system and the second system of the steering device includes a turning actuator including the power source to turn a wheel, and a reaction force actuator including the different power source to apply an operation reaction force to a steering operation member, and each of the first system and the second system of the control drive device includes the control drive device for the turning actuator and the control drive device for the reaction force actuator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram illustrating an overall configuration of a steering system of an embodiment;

FIG. 1B is a diagram illustrating a configuration of an electronic control unit that is a drive control device;

FIG. 2A is a diagram schematically illustrating a power supply system of the steering system of the embodiment;

FIG. 2B is a diagram schematically illustrating an internal configuration of a backup power supply device included in the power supply system;

FIG. 3A is a diagram schematically illustrating a power supply system of the related art;

FIG. 3B is a diagram schematically illustrating an internal configuration of a backup power supply device included in the power supply system of the related art;

FIG. 4A is a diagram illustrating a power supply system of a first modification example that can be adopted in the steering system of the embodiment;

FIG. 4B is a diagram illustrating a power supply system of a second modification example that can be adopted in the steering system of the embodiment;

FIG. 5A is a diagram schematically illustrating a power supply system of a third modification example that can be adopted in the steering system of the embodiment;

FIG. 5B is a diagram schematically illustrating an internal configuration of a backup power supply device included in the power supply system of the third modification example; and

FIG. 6 is a flowchart of an ending processing program to be executed for ending the actuation of the electronic control unit.

### DETAILED DESCRIPTION OF EMBODIMENTS

Hereinafter, as a mode for carrying out the disclosure, a steering system according to an embodiment of the disclosure is described in detail with reference to the drawings. It is to be noted that, besides the following embodiment, the disclosure can be carried out in various forms including the forms described in the above section “SUMMARY” and various modified or improved forms that are made based on the knowledge of those skilled in the art.

### [A] Overall Configuration of Steering System

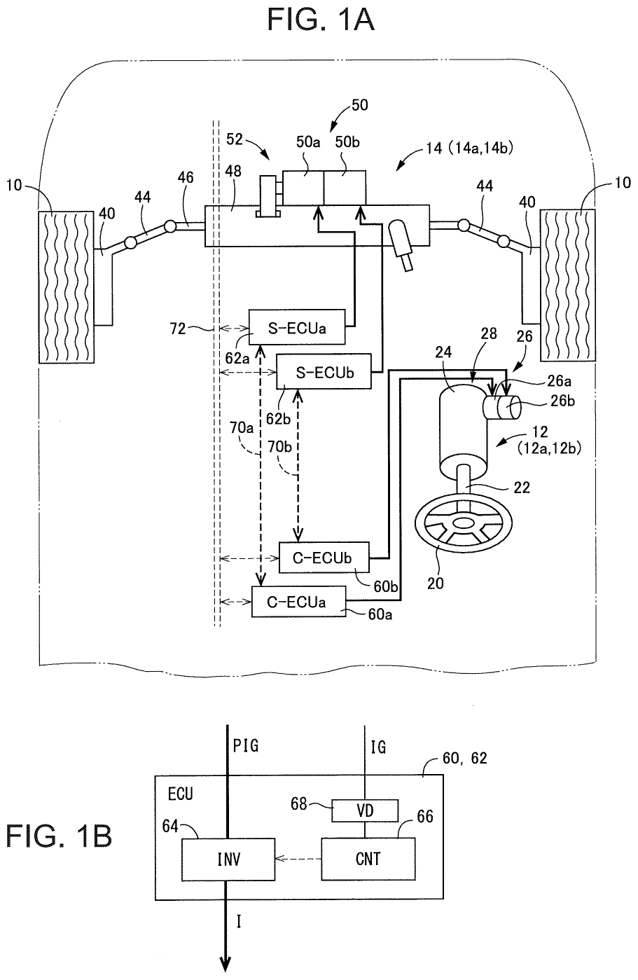

A steering system according to an embodiment (hereinafter sometimes referred to as “this steering system”) to be mounted on a vehicle is, as schematically illustrated in FIG. 1A, a system for turning two wheels (that are front wheels) 10 each being a turned wheel, and is a steer-by-wire steering system including a reaction force actuator 12 and a turning actuator 14 that are mechanically independent of each other.

The reaction force actuator 12 has a function of receiving an operation of a steering wheel 20 serving as an operation member on which a turning operation (steering operation) is performed by a driver, and includes: (a) a steering shaft 22 having the steering wheel 20 mounted at its distal end; (b) a steering column 24 that rotatably holds the steering shaft 22 and is supported by an instrument panel reinforcement (not illustrated); and (c) a reaction force applying mechanism 28 that is provided on the steering column 24 and applies an operation reaction force that is a reaction force against the steering operation to the steering wheel 20 via the steering shaft 22 with the use of a reaction force motor 26 that is an electric motor as a power source. The reaction force actuator 12 has a general structure, and hence the description of the specific structure of the reaction force actuator 12 is omitted.

The reaction force motor 26 is a three-phase brushless DC motor. Magnets are provided on an outer periphery of a rotary shaft, and coils are arranged on a housing so as to face those magnets. The reaction force motor 26 is a two-system motor in which two sets of coils are arranged for one magnet. Hereinafter, the two systems are sometimes referred to as “first reaction force motor 26a” and “second reaction force motor 26b”. That is, the reaction force actuator 12 is constituted of an actuator including two systems (that are hereinafter sometimes referred to as “first reaction force actuator 12a” and “second reaction force actuator 12b”) that become redundant systems of one another.

Each of the wheels 10 is supported by a vehicle body so that its direction is changeable via a steering knuckle 40 that is one component of a suspension device. The turning actuator 14 pivots the steering knuckles 40 to integrally turn the two wheels 10. The turning actuator 14 includes: (a) a steering rod (also sometimes called “rack bar”) 46 coupled at both ends thereof to the right and left steering knuckles 40 via link rods 44; (b) a housing 48 that supports the steering rod 46 such that the steering rod 46 is movable to right and left sides, and is fixedly held by the vehicle body; and (c) a rod moving mechanism 52 that uses a turning motor 50 that is an electric motor as a power source to move the steering rod 46 to the right and left sides. The rod moving mechanism 52 mainly includes a ball screw mechanism constituted of a ball groove threadedly provided in the steering rod 46, and a nut that threadedly engages the ball groove via bearing balls and is rotated by the turning motor 50. The turning actuator 14 has a general structure, and hence the description of the specific structure thereof is omitted.

The turning motor 50 is also a two-system three-phase brushless DC motor having a structure similar to that of the reaction force motor 26. Hereinafter, the two systems are sometimes referred to as “first turning motor 50a” and “second turning motor 50b”. Thus, the turning actuator 14 is constituted of an actuator including two systems (that are hereinafter sometimes referred to as “first turning actuator 14a” and “second turning actuator 14b”) that become redundant systems of one another.

The control of the reaction force actuator 12, in detail, the control of the operation reaction force, that is, the control of the reaction force motor 26 is executed by two reaction force electronic control units (hereinafter sometimes referred to as “reaction force ECUs”) 60a, 60b that correspond to the two systems of the reaction force actuator 12 and are control drive devices for the two systems. In more detail, the control and drive of the first reaction force actuator 12a is performed by the first reaction force ECU 60a, and the control and drive of the second reaction force actuator 12b is performed by the second reaction force ECU 60b. Similarly, the control of the turning actuator 14, in detail, the control regarding the turning of the wheels, that is, the control of the turning motor 50 is executed by two turning electronic control units (hereinafter sometimes referred to as “turning ECUs”) 62a, 62b that correspond to the two systems of the turning actuator 14 and are control drive devices for the two systems. In more detail, the control and drive of the first turning actuator 14a is performed by the first turning ECU 62a, and the control and drive of the second turning actuator 14b is performed by the second turning ECU 62b. Incidentally, the first reaction force ECU 60a and the second reaction force ECU 60b are sometimes collectively referred to as “reaction force ECU 60”, and the first turning ECU 62a and the second turning ECU 62b are sometimes collectively referred to as “turning ECU 62”. It is to be noted that, in the drawings, the first reaction force ECU 60a, the second reaction force ECU 60b, the first turning ECU 62a, and the second turning ECU 62b are represented by C-ECU 60a, C-ECU 60b, S-ECU 62a, and S-ECU 62b, respectively.

As illustrated in FIG. 1B, the reaction force ECU 60 and the turning ECU 62 (hereinafter sometimes collectively referred to as “ECUs 60, 62”) each include an inverter 64 that is a driver (drive circuit), and a controller 66 that controls the inverter 64. The controller 66 includes a computer constituted of a CPU, a ROM, a RAM, and the like as a main component. Electric power is supplied to the inverter 64 and the controller 66 from buses to be described later. In more detail, electric power (hereinafter sometimes referred to as “PIG electric power”) is supplied to the inverter 64 via an electric power supply line indicated by “PIG” in the drawing, and electric power (hereinafter sometimes referred to as “IG electric power”) is supplied to the controller 66 via an electric power supply line indicated by “IG” in the drawing. A control signal is transmitted from the controller 66 to the inverter 64, and, based on the control signal, the inverter 64 is actuated so that a drive current I is supplied to the reaction force motor 26 or the turning motor 50. It is to be noted that the PIG electric power and the IG electric power are supplied to the reaction force ECU 60 and the turning ECU 62, respectively, at the same voltage, but the controller 66 is actuated at a relatively low voltage, and hence the IG electric power is supplied to the controller 66 via a step-down transformer 68. It is to be noted that the PIG electric power becomes the drive electric power for the reaction force motor 26 or the turning motor 50, and hence is larger than the IG electric power. That is, a current that is large to some extent is supplied to the inverter 64.

This steering system is, when being considered as a whole, a two-system system in which the first reaction force actuator 12a, the first turning actuator 14a, the first reaction force ECU 60a, and the first turning ECU 62a configure the first system, and the second reaction force actuator 12b, the second turning actuator 14b, the second reaction force ECU 60b, and the second turning ECU 62b configure the second system. Further, from another viewpoint, the first reaction force actuator 12a and the second reaction force actuator 12b respectively function as a first system and a second system of one reaction force actuator 12, and the first turning actuator 14a and the second turning actuator 14b respectively function as a first system and a second system of one turning actuator 14. Moreover, it is possible to regard that the first reaction force actuator 12a and the first turning actuator 14a configure a first system of one steering device, and the second reaction force actuator 12b and the second turning actuator 14b configure a second system of the one steering device. It is to be noted that one of the first system and the second system may be referred to as “main system”, and the other one thereof may be referred to as “sub-system”.

As illustrated in FIG. 1A, the first reaction force ECU 60a and the first turning ECU 62a are connected to each other by a first dedicated communication line 70a, and the second reaction force ECU 60b and the second turning ECU 62b are connected to each other by a second dedicated communication line 70b. In order to allow communication to the reaction force ECU 60 or the turning ECU 62 in a different system, and in order to allow communication to another system or the like, each reaction force ECU 60 and each turning ECU 62 are connected to a car area network or controllable area network (CAN) 72 serving as a common communication line. It is to be noted that the control of the operation reaction force by the reaction force ECU 60 and the control regarding the turning of the wheels by the turning ECU 62 are general types of control, and hence the description thereof is omitted here. Incidentally, at normal times, both of the first reaction force actuator 12a and the first turning actuator 14a are evenly responsible for the operation reaction force required as a whole, and the first turning actuator 14a and the second turning actuator 14b are evenly responsible for a turning force (a force exerted for turning the wheels) required as a whole.

### [B] Power Supply System

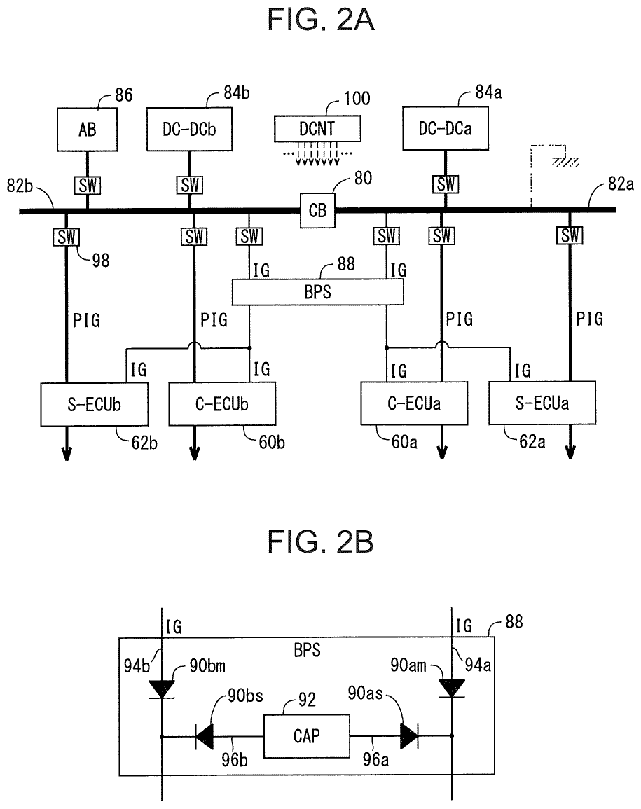

This steering system includes a power supply system as illustrated in FIG. 2A. In more detail, the power supply system includes a first bus 82a and a second bus 82b (hereinafter sometimes collectively referred to as “bus 82”) that are two electric power supply lines disposed in series to each other via a circuit breaker 80. At normal times, the first bus 82a and the second bus 82b are communicated with each other, and the communication is cut off by the circuit breaker 80 when some kind of event occurs. It is to be noted that both of the first bus 82a and the second bus 82b are disposed in a form of busbars.

A first converter 84a that is a first power supply is connected to the first bus 82a, and a second converter 84b that is a second power supply is connected to the second bus 82b. The first converter 84a and the second converter 84b (that are respectively indicated by “DC-DCa” and “DC-DCb” in the drawing) each receive supply of electric power from a high-voltage drive battery mounted on the vehicle, and respectively supply electric power to the first bus 82a and the second bus 82b. Further, an auxiliary battery (that is indicated by “AB” in the drawing) 86 that functions as the second power supply is connected to the second bus 82b. The auxiliary battery 86 is what is called a lead battery. Although illustration is omitted in the drawing, other devices such as a brake device are also connected to the first bus 82a and the second bus 82b, and the first converter 84a, the second converter 84b, and the auxiliary battery 86 supply electric power to those other devices as well. Although a detailed description is omitted, the auxiliary battery 86 also has a function of storing regenerative electric power obtained from the steering device or other devices. It is to be noted that, in the following description, the first converter 84a, the second converter 84b, and the auxiliary battery 86 are sometimes collectively referred to as “normal power supply”.

Although a detailed description is omitted, as compared to the voltage of the electric power from the first converter 84a, the voltage of the electric power from the second converter 84b is set to be slightly lower, and the electric power is normally supplied from the first converter 84a. When the communication between the first bus 82a and the second bus 82b is cut off by the circuit breaker 80, electric power can be supplied to the first bus 82a from the first converter 84a, and electric power can be supplied to the second bus 82b from the second converter 84b.

The first reaction force ECU 60a and the first turning ECU 62a that are each the first system of the control drive device are connected to the first bus 82a, and the second reaction force ECU 60b and the second turning ECU 62b that are each the second system of the control drive device are connected to the second bus 82b. In more detail, the first reaction force ECU 60a and the first turning ECU 62a are connected to the first bus 82a such that the PIG electric power is directly input thereto from the first bus 82a, and the second reaction force ECU 60b and the second turning ECU 62b are connected to the second bus 82b such that the PIG electric power is directly input thereto from the second bus 82b.

Meanwhile, this power supply system includes a backup power supply device (that is indicated by “BPS” in the drawing) 88. The first reaction force ECU 60a and the first turning ECU 62a are connected to the first bus 82a such that the IG electric power is input thereto from the first bus 82a via the backup power supply device 88, and the second reaction force ECU 60b and the second turning ECU 62b are connected to the second bus 82b such that the IG electric power is input thereto from the second bus 82b via the backup power supply device 88. In more detail, the backup power supply device 88 has an internal configuration as schematically illustrated in FIG. 2B, and is configured such that the IG electric power from the first bus 82a passes through itself to be transmitted to the first reaction force ECU 60a and the first turning ECU 62a and the IG electric power from the second bus 82b passes through itself to be transmitted to the second reaction force ECU 60b and the second turning ECU 62b.

In further more detail, the backup power supply device 88 includes four rectifiers 90 and a capacitor (that is indicated by “CAP” in the drawing) 92. The four rectifiers 90 each permit passage of a current in one direction, and each inhibit passage of a current in the opposite direction. The capacitor 92 is a battery having a relatively small capacity. In more detail, the four rectifiers 90 are each what is called a diode, and include a first main rectifier 90am provided on a first main path 94a provided for outputting the IG electric power from the first bus 82a to the first reaction force ECU 60a and the first turning ECU 62a, a second main rectifier 90bm provided in a second main path 94b provided for outputting the IG electric power from the second bus 82b to the second reaction force ECU 60b and the second turning ECU 62b, a first sub-rectifier 90as provided in a first sub-path 96a that provides connection between the capacitor 92 and a part of the first main path 94a on the downstream side of the first main rectifier 90am, and a second sub-rectifier 90bs provided in a second-sub path 96b that provides connection between the capacitor 92 and a part of the second main path 94b on the downstream side of the second main rectifier 90bm.

The capacitor 92 can supply electric power having a voltage slightly lower than the voltage of the IG electric power supplied from the first bus 82a and the second bus 82b. Accordingly, when the IG electric power is supplied from the first bus 82a, the IG electric power is supplied to the first reaction force ECU 60a and the first turning ECU 62a, and, when the IG electric power is supplied from the second bus 82b, the electric power is supplied to the second reaction force ECU 60b and the second turning ECU 62b. In addition, when the supply of the IG electric power from the first bus 82a is cut off, the electric power from the capacitor 92 is supplied as the IG electric power to the first reaction force ECU 60a and the first turning ECU 62a, and, when the supply of the IG electric power from the second bus 82b is cut off, the electric power from the capacitor 92 is supplied as the IG electric power to the second reaction force ECU 60b and the second turning ECU 62b. That is, the backup power supply device 88 is configured to cause the IG electric power supplied to the ECUs 60, 62 of the first system and the second system from the first bus 82a and the second bus 82b to pass through itself, and, when the supply of the IG electric power from both of the first bus 82a and the second bus 82b is cut off, supply the IG electric power to both of the ECUs 60, 62 of the first system and the second system from the battery included in itself automatically, that is, without requiring any special control. In other words, the backup power supply device 88 is configured to use a voltage difference to switch the supply source of the electric power from the normal power supply to the battery included in itself instantly, that is, without a time lag. Incidentally, the backup power supply device may supply the PIG electric power as well, but the capacitor 92 has a small capacity, and hence, when the PIG electric power is supplied as well, the electric power can be supplied only for a relatively short time.

Incidentally, although the illustration is omitted in the drawing, the backup power supply device 88 includes a circuit that receives supply of electric power from at least one of the first bus 82a and the second bus 82b to charge the capacitor 92, and, at normal times, the capacitor 92 maintains a charged state.

It is to be noted that, as illustrated in FIG. 2A, switches (indicated by “SW” in the drawing) 98 that are switching devices are provided between the first bus 82a and each of the first converter 84a, the first reaction force ECU 60a, the first turning ECU 62a, and the backup power supply device 88 and between the second bus 82b and each of the second converter 84b, the second reaction force ECU 60b, the second turning ECU 62b, and the backup power supply device 88. In simple terms, the switches 98 are brought to a closed state when an ignition switch of the vehicle is ON, and are brought to an open state when the ignition switch is OFF. Although a detailed description is omitted, the actuation of the switches 98 and the actuation of the circuit breaker 80 are controlled by a domain controller (that is indicated by “DCNT” in the drawing) 100 that is a control device.

[C] Problem that Occurs when Bus has Ground Fault And how to Address this Problem

In this steering system including the above-mentioned power supply system (hereinafter sometimes referred to as “the power supply system of the embodiment”), as described above, at normal times, the first bus 82a and the second bus 82b are communicated with each other, and the electric power is supplied from the first converter 84a to all of the first reaction force ECU 60a, the first turning ECU 62a, the second reaction force ECU 60b, and the second turning ECU 62b.

In this steering system, for example, there is considered a case in which, as indicated by the long dashed double-short dashed line in FIG. 2A, a ground fault, that is, a short-circuit that drops a voltage to a ground potential occurs in the first bus 82a. In this case, since the first bus 82a and the second bus 82b are communicated with each other, no electric power is supplied from any of the first converter 84a, the second converter 84b, and the auxiliary battery 86 to any of the reaction force ECUs 60a, 60b and the turning ECUs 62a, 62b. In view of the foregoing, in this steering system, when the ground fault as described above occurs, the circuit breaker 80 cuts off the communication between the first bus 82a and the second bus 82b so that the supply of the electric power from the second converter 84b to the second reaction force ECU 60b and the second turning ECU 62b via the second bus 82b is ensured.

However, when the ground fault occurs, a time lag occurs to some extent from the detection of the occurrence of the ground fault until the actuation of the circuit breaker 80. While the time lag is occurring, that is, until the supply of the electric power from the second converter 84b to the second reaction force ECU 60b and the second turning ECU 62b is recovered, there arises a problem that no electric power is supplied to any of the second reaction force ECU 60b and the second turning ECU 62b. In particular, when the supply of the IG electric power to the controller 66 of the ECU 60 is cut off even for a moment, the actuation of the controller 66 is reset. Thus, when the first bus 82a has a ground fault, even when the supply of the electric power to the second reaction force ECU 60b and the second turning ECU 62b is recovered, the second system of the steering device is not appropriately actuated. That is, there may arise a problem that both of the first system and the second system of the steering device are not appropriately actuated.

In order to address the above-mentioned problem, in this steering system, even during the time lag, the supply of the IG electric power is automatically continued from the backup power supply device 88 to the controllers 66 of the second reaction force ECU 60b and the second turning ECU 62b. Thus, after the supply of the electric power from the second converter 84b is recovered, the appropriate actuation of the second system of the steering device is ensured by the electric power.

The description above is description of a case in which the first bus 82a has a ground fault, but a similar problem arises even when the second bus 82b has a ground fault. Although a detailed description is omitted, even when the second bus 82b has a ground fault and a time lag occurs, during the time lag, the supply of the IG electric power is automatically continued from the backup power supply device 88 to the controllers 66 of the first reaction force ECU 60a and the first turning ECU 62a. Thus, after the supply of the electric power from the first converter 84a via the first bus 82a is recovered, the appropriate actuation of the first system of the steering device is ensured by the electric power. That is, in this steering system, even when the ground fault occurs in any of the first bus 82a and the second bus 82b, appropriate actuation of a corresponding one of the first system and the second system of the steering device is ensured.

### [D] Regarding Power Supply System of Related Art

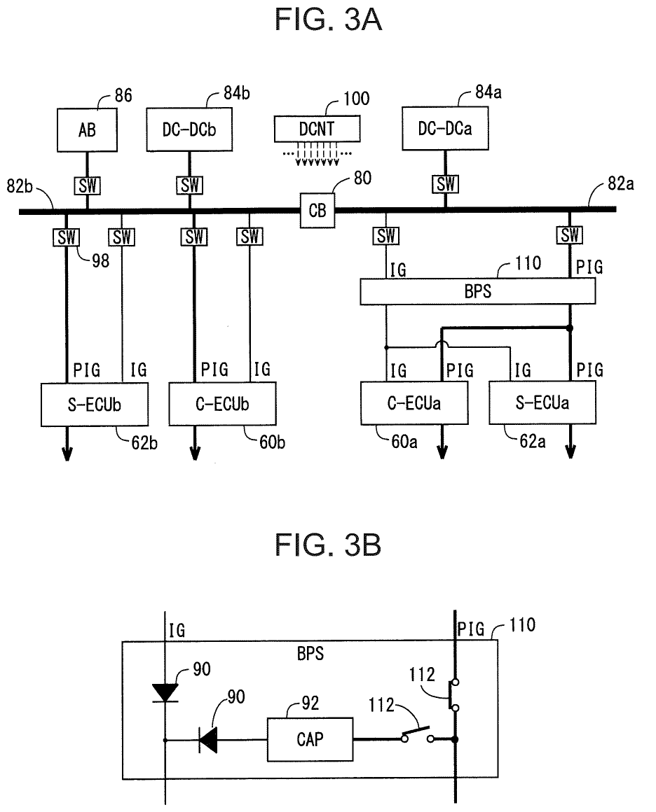

The power supply system of the related art is illustrated in FIG. 3A. In the following description, the same components as the power supply system of the steering system of the embodiment are denoted by the same reference symbols, and a detailed description thereof is omitted.

In the power supply system of the related art, a backup power supply device 110 is configured to perform backup only for the first system. In more detail, when the supply of the electric power from the first bus 82a is cut off, the backup power supply device 110 supplies not only the IG electric power but also the PIG electric power from the capacitor 92 to the first reaction force ECU 60a and the first turning ECU 62a.

Incidentally, regarding the PIG electric power, relatively large current supply is caused, and hence the backup power supply device 110 can switch from the electric power supply from the first bus 82a to the electric power supply from the capacitor 92 by semiconductor switching elements 112 instead of the rectifiers 90. Although a detailed description is omitted, the backup power supply device 110 has a built-in controller, and the actuation of the switching elements 112 is controlled by the controller depending on the electric power from the capacitor 92.

According to the power supply system of the related art, for example, when a ground fault occurs in the second bus 82b, the circuit breaker 80 cuts off the communication between the first bus 82a and the second bus 82b. Thus, even during a period until the electric power supply from the first bus 82a is recovered, the backup power supply device 110 suppresses an interruption of the supply of the IG electric power to the first reaction force ECU 60a and the first turning ECU 62a. Further, after the electric power supply from the first bus 82a is recovered, the appropriate actuation of the first system of the steering device is maintained by the electric power. Incidentally, the second system of the steering device is not actuated from when the ground fault occurs.

In contrast, when the ground fault occurs in the first bus 82a, during a period from the time point at which the ground fault occurs to when the communication between the first bus 82a and the second bus 82b is cut off by the circuit breaker 80, no electric power is supplied to the second reaction force ECU 60b and the second turning ECU 62b, and the actuation of the controllers 66 of the second reaction force ECU 60b and the second turning ECU 62b is reset. As a result, even when the supply of the electric power from the second bus 82b is recovered, the second system of the steering device is not actuated appropriately. Meanwhile, the first system of the steering device is actuated by receiving the electric power supply from the backup power supply device 110, and cannot be actuated after the electricity amount stored in the capacitor 92 runs out. This time of actuation is relatively short. That is, in the power supply system of the related art, when the ground fault occurs in the first bus 82a, only the first system of the steering device is appropriately actuated, but the actuation does not always continue for a sufficient time. The power supply system of the related art experiences such a problem.

As described above, in the steering system of the embodiment, even when the ground fault occurs in any of the first bus 82a and the second bus 82b, the appropriate actuation of a corresponding one of the first system and the second system of the steering device is ensured for a sufficient time, and the problem experienced by the power supply system of the related art is solved.

### [E] Modification Examples of Power Supply System

The steering system of the embodiment can adopt some power supply systems other than the power supply system of the above-mentioned embodiment. In the following, some modification examples of the power supply system that can be adopted in the steering system of the embodiment are simply described.

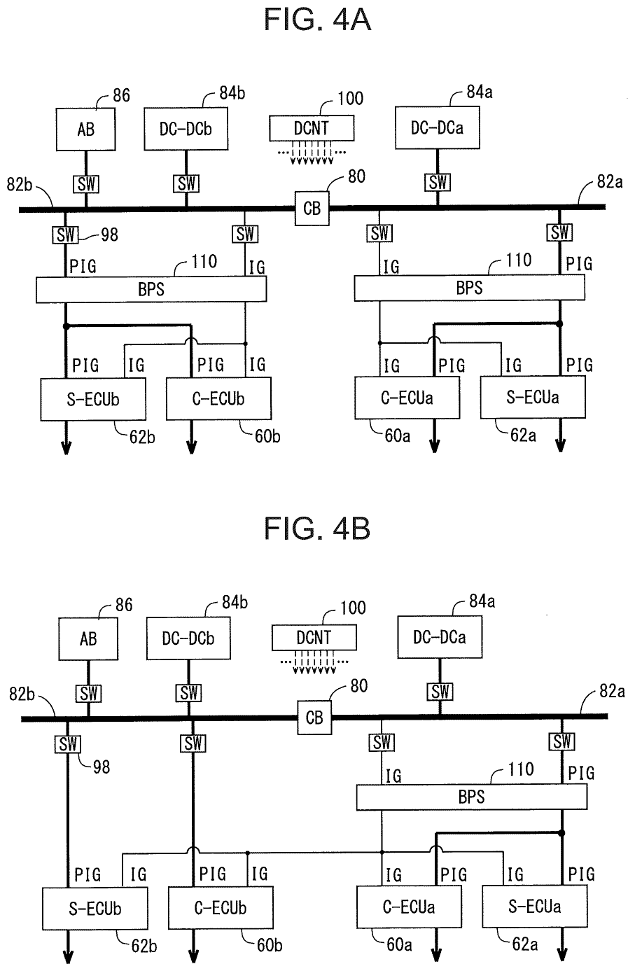

A power supply system of a first modification example is a system in which, as illustrated in FIG. 4A, where the backup power supply device 110 adopted in the power supply system of the related art is provided not only on the first system side but also on the second system side. With this system, although two backup power supply devices are required, even when the ground fault occurs in any of the first bus 82a and the second bus 82b, during the time lag described above, also the IG electric power is supplied to all of the first reaction force ECU 60a, the first turning ECU 62a, the second reaction force ECU 60b, and the second turning ECU 62b. Accordingly, one of the first system and the second system of the steering device on the side without the ground fault is continuously actuated appropriately through recovery of the electric power supply from a corresponding one of the first bus 82a and the second bus 82b. The other one of the first system and the second system of the steering device on the side with the ground fault is appropriately actuated although it is as long as the electric power stored in the capacitor 92 of the backup power supply device 110 continues. This power supply system requires two backup power supply devices, but a steering system having a higher reliability can be constructed.

It is to be noted that this power supply system can be considered to configure, by the two backup power supply devices, one backup power supply device that automatically supplies, when the supply of the electric power from both of the first bus 82a and the second bus 82b is cut off, the electric power from the battery included in itself to the controllers 66 of all of the first reaction force ECU 60a, the first turning ECU 62a, the second reaction force ECU 60b, and the second turning ECU 62b. It is to be noted that, in the backup power supply device 110, the supply source of the PIG electric power may be automatically switched between the first bus 82a or the second bus 82b and the capacitor 92 by the rectifiers 90, similarly to the IG electric power.

A power supply system of a second modification example is configured to supply, as illustrated in FIG. 4B, the IG electric power also to the second reaction force ECU 60b and the second turning ECU 62b via the backup power supply device 110 adopted in the power supply system of the related art. Accordingly, unlike the power supply system of the related art, even when the ground fault occurs in the first bus 82a, the above-mentioned time lag does not occur in the second system of the steering device, and the appropriate actuation of the second system of the steering device is maintained through the recovery of the electric power supply from the second bus 82b.

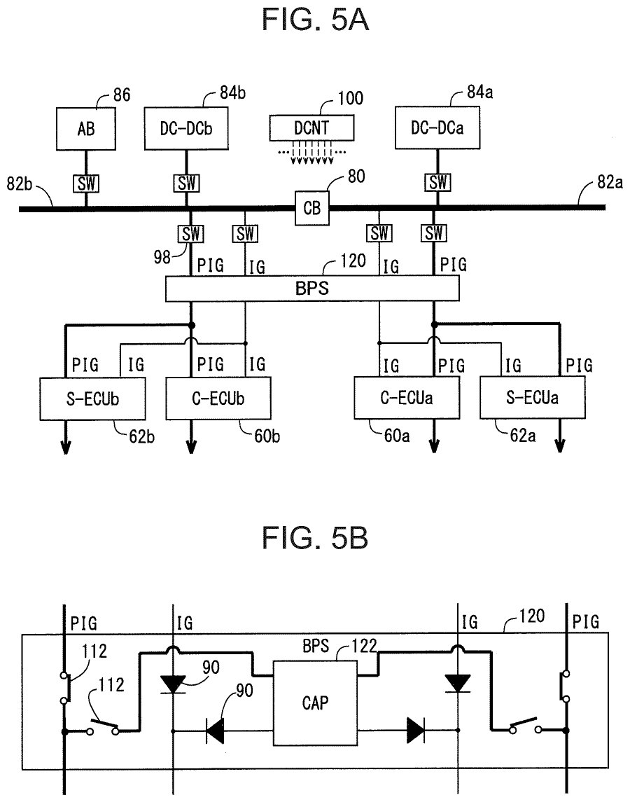

A power supply system of a third modification example includes, as illustrated in FIG. 5A, one backup power supply device 120, and the backup power supply device 120 includes one capacitor 122. As illustrated in FIG. 5B, the backup power supply device 120 is configured to receive the IG electric power and the PIG electric power from each of the first bus 82a and the second bus 82b, and to supply, when the electric power supply from the first bus 82a and the second bus 82b is cut off, the IG electric power and the PIG electric power from the capacitor 122 to the first reaction force ECU 60a, the first turning ECU 62a, the second reaction force ECU 60b, and the second turning ECU 62b.

With this power supply system, similarly to the power supply system of the first modification example, even when the ground fault occurs in any of the first bus 82a and the second bus 82b, during the time lag described above, the IG electric power is supplied to all of the first reaction force ECU 60a, the first turning ECU 62a, the second reaction force ECU 60b, and the second turning ECU 62b. After the electric power supply from one of the first bus 82a and the second bus 82b without the ground fault is recovered, the appropriate actuation of a corresponding one of the first system and the second system of the steering device is maintained by the electric power. In addition, a corresponding one of the first system and the second system of the steering device on the side with the ground fault is also appropriately actuated although it is until the electric power stored in the capacitor 122 runs out. Incidentally, as compared to the capacitor 92 included in the backup power supply device 110 of the power supply system of the first modification example, the capacitor 122 included in the backup power supply device 120 of this power supply system has a larger capacity, and an appropriate actuation time of any of the first system and the second system of the steering device on the side with the ground fault is relatively long. It is to be noted that, in the backup power supply device 120 as well, the supply source of the PIG electric power may be automatically switched between a corresponding one of the first bus 82a and the second bus 82b and the capacitor 122 by the rectifiers 90, similarly to the IG electric power.

Some power supply systems have been described above, but, in all of the power supply systems, the first converter 84a is connected to the first bus 82a, and the second converter 84b and the auxiliary battery 86 are connected to the second bus 82b. In the power supply system that can be adopted in the steering system of the embodiment, the auxiliary battery 86 may be connected to the first bus 82a. Further, both of the first converter 84a and the second converter 84b may be connected to one of the first bus 82a and the second bus 82b, and only the auxiliary battery 86 may be connected to the other one thereof.

### [F] Ending Processing of Control Drive Device

Each of the first reaction force ECU 60a, the first turning ECU 62a, the second reaction force ECU 60b, and the second turning ECU 62b executes the processing for ending its own actuation. In a steering system including no backup power supply, its own actuation has been ended when, for example, two conditions are satisfied, that is, no electric power is actually supplied from the normal power supply, that is, the corresponding switch 98 is brought to a closed state and the electric power (voltage) supplied to itself is reduced. Incidentally, switch opening-closing information that is information about opening and closing of the corresponding switch 98 is transmitted by the domain controller 100 via the CAN 72.

However, when the power supply system including the backup power supply device is adopted, the electric power is supplied from the backup power supply device even when no electric power is supplied from the normal power supply, and hence it is not preferred to end its own actuation when the above-mentioned two conditions are satisfied. In view of the foregoing, in the steering system of the embodiment, the backup power supply device 88, 110, 120 detects a BPS input voltage that is an input-side voltage and transmits a BPS input voltage signal that is a signal about the BPS input voltage to the ECUs 60, 62 via the CAN 72. The corresponding ECUs 60, 62 end their own processing based on the signal.

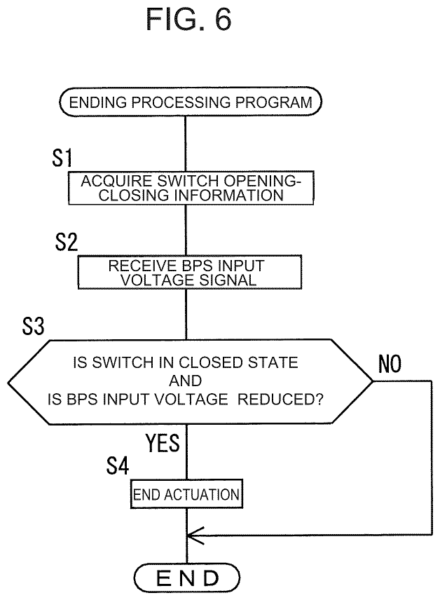

Specifically, the controllers 66 of the ECUs 60, 62 connected to the backup power supply device end their own actuation in accordance with the ending processing program shown in the flowchart of FIG. 6. The ending processing is described along the flowchart. The controllers 66 of the ECUs 60, 62 first acquire the switch opening-closing information in Step 1 (hereinafter abbreviated as “S1”. The same holds true in the other steps.), and, in S2, receive the BPS input voltage signal. Then, when, in S3, two conditions of the closed state of the switch 98 and the reduction of the BPS input voltage of the backup power supply device 88, 110, 120 (for example, the BPS input voltage of substantially 0 V) are satisfied, in S4, the controllers 66 stop their own actuation. That is, the actuation of the reaction force actuator 12 and the turning actuator 14 that are controlled and driven by the ECUs 60, 62 including the controllers 66 is stopped. It is to be noted that this ending processing program is repeatedly executed in a short time interval.

What is claimed is:

1. A steering system to be mounted on a vehicle, the steering system comprising:
a steering device including two systems of a first system and a second system, the two systems each including a power source;
a control drive device including two systems of a first system and a second system to control and drive the first system and the second system of the steering device, respectively, the two systems of the control drive device each including a driver that drives the power source and a controller that controls the driver;
two electric power supply buses connected in series to each other, the two electric power supply buses including a first bus to which the first system of the control drive device is connected to supply electric power to the first system of the control drive device, and a second bus to which the second system of the control drive device is connected to supply electric power to the second system of the control drive device;
a circuit breaker that disconnects the first bus and the second bus;
a first power supply connected to the first bus and a second power supply connected to the second bus; and
a backup power supply device that includes a battery and is configured to supply electric power from the battery, wherein
the steering system is configured such that, at normal times, in a state in which the first bus and the second bus are communicated with each other, electric power is supplied from at least one of the first power supply and the second power supply, and, when one of the first bus and the second bus has a ground fault, the circuit breaker disconnects the first bus and the second bus such that the electric power is supplied via another one of the first bus and the second bus from a corresponding one of the first power supply and the second power supply connected to the other one of the first bus and the second bus to a corresponding one of the first system and the second system of the control drive device connected to the other one of the first bus and the second bus, and
the backup power supply device is configured to cause the electric power supplied from at least one of the first bus and the second bus to pass through itself, and, when supply of the electric power is cut off, automatically supply the electric power from the battery included in itself to at least the controllers of both of the first system and the second system of the control drive device.

2. The steering system according to claim 1, wherein:
the steering system is a steer-by-wire steering system;
each of the first system and the second system of the steering device includes a turning actuator including the power source to turn a wheel, and a reaction force actuator including the different power source to apply an operation reaction force to a steering operation member; and
each of the first system and the second system of the control drive device includes the control drive device for the turning actuator and the control drive device for the reaction force actuator.

3. The steering system according to claim 1, wherein the backup power supply device is configured to supply, with respect to both of the first system and the second system of the control drive device, the electric power from the battery to only the controller out of the driver and the controller.

4. The steering system according to claim 1, wherein the backup power supply device is configured to supply, with respect to at least one of the first system and the second system of the control drive device, the electric power from the battery to both of the driver and the controller.

5. The steering system according to claim 1, wherein the backup power supply device includes a first backup power supply device configured to supply the electric power to the first system of the control drive device, and a second backup power supply device configured to supply the electric power to the second system of the control drive device.
